(19) United States
(12) Patent Application Publication
(10) Pub. No.: US 2006/0147667 A1
(43) Pub. Date: Jul. 6, 2006

(54) Pre-cut duct tape shapes

(75) Inventor: Thomas Salmon, Franklin, MA (US)

Correspondence Address: TYCO PLASTICS AND ADHESIVES, 7 ROSZEL ROAD, PRINCETON, NJ, 08540, US

(73) Assignee: TYCO ADHESIVES LP

(21) Appl. No.: 11/027,827

(22) Filed: Dec. 30, 2004

(51) Int. Cl. B32B 33/00

(52) U.S. Cl. 428/42.3; 428/40.1

(57) ABSTRACT

A pre-shaped adhesive and method are disclosed. The adhesive includes predetermined shaped single-sided adhesives adapted to cover and conform to the shape of corresponding adhesive element receiving areas. The predetermined shaped single-sided adhesives are removably stackable and dispensable in a number of disclosed methods.

### BACKGROUND OF THE INVENTION

Embodiments of the present invention generally relate to adhesives. In particular, embodiments of the present invention relates to pre-shaped adhesives and methods.

Many industrial, commercial and residential projects require repair, sealing, joining, and/or fastening of materials that have holes, gaps or openings. Some of these areas can be geometric shapes or irregular shapes.

Currently, adhesives are sold as tape, which is available in rolls of about 2-4 inch widths. If areas needing an adhesive are large or not square or rectangular in shape, currently available adhesive tapes are inefficient in repairing, sealing, joining, and/or fastening these areas. Due to existing shape and size limitations of adhesive tape, multiple pieces or applications are required to cover these large areas of various shapes and sizes. Multiple applications are undesirable because of the added weight, bulk and multiple overlaps in areas prone to leakage, debris and sites for tearing.

In addition, known adhesive tape does not offer aesthetically pleasing options. Generally, tape comes in a limited number of colors and textures. Some applications, such as areas needing repair in air ducts, are visible. When large areas need to be covered after performing work on visible applications, it is undesirable to have adhesive tape that contrasts in color and texture with the visible applications.

Therefore, there is a need in the art for improved adhesives.

### SUMMARY OF THE INVENTION

### BRIEF DESCRIPTION OF THE DRAWINGS

So the manner in which the above recited features of the embodiments of the present invention can be understood in detail, a more particular description, briefly summarized above, may be had by reference to embodiments, some of which are illustrated in the appended drawings. It is noted; however, the appended drawings illustrate only typical embodiments of this invention and are therefore not to be considered limiting of its scope, for the invention may admit to other equally effective embodiments.

FIG. 1A-1D are top plan views showing a single-sided adhesive in various shapes in accordance with an embodiment of the present invention;

FIG. 2 is a sectional view of the substrate of FIG. 1 along edge a-a showing an adhesive side and corresponding non-adhesive side;

FIG. 3A is a plan view of an adhesive receiving area;

FIG. 3B is a plan view of the adhesive receiving of FIG. 3A area after a single-sided adhesive is applied;

FIG. 3C is a perspective view of another adhesive receiving area;

FIG. 3D is a perspective view of the adhesive receiving area of FIG. 3C after a single-sided adhesive is applied;

FIG. 4 is a perspective view of an embodiment of the present invention showing a plurality of single-sided adhesives in a stack;

FIG. 5 is a perspective view of an embodiment of the present invention showing a plurality of single-sided adhesives dispensable from a roll;

FIG. 6 is a perspective view of an embodiment of the present invention showing a plurality of single-sided adhesives dispensable from a plurality of rolls in a single dispensing unit; and

FIG. 7 is a perspective view of an embodiment of the present invention showing a plurality of single-sided adhesives dispensable as an individual unit having a non-adhesive backing.

To facilitate understanding, identical reference numerals have been used, where possible, to designate identical elements that are common to the figures.

### DETAILED DESCRIPTION OF THE PREFERRED EMBODIMENT

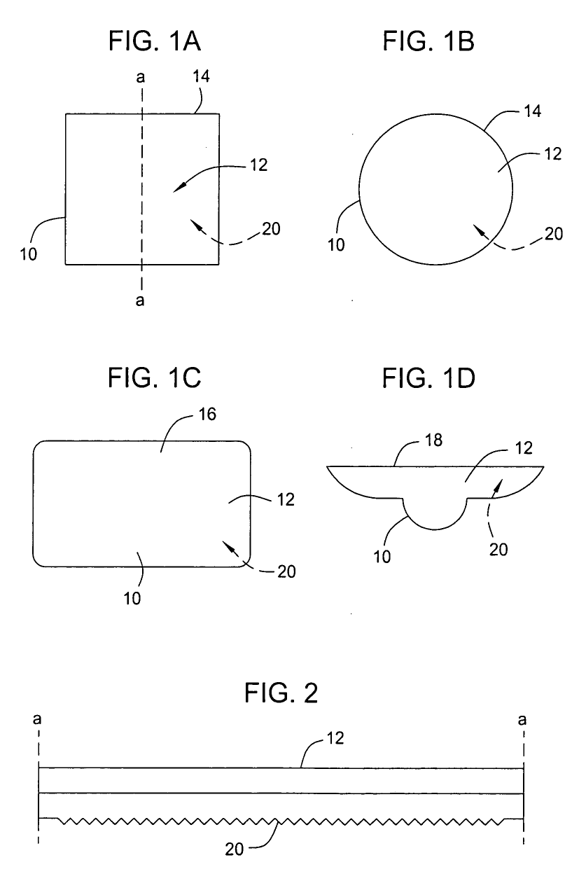

FIG. 1A depicts a top plan view of a single-sided adhesive element 10. Element 10 includes a non-adhesive side 12 and an adhesive side 20 opposite the non-adhesive side 12. Illustratively, one embodiment of the present invention includes a pre-cut geometric shape 14, in particular, a parallelogram. This parallelogram can be a square, a rectangle or any other type of parallelogram and the like. Alternatively, embodiments of the present invention can include various shapes and sizes that correspond to an adhesive element receiving area.

FIG. 1B depicts a similar plan view as in FIG. 1A, except that the single-sided adhesive element 10 is pre-cut into a different geometric shape 14, namely, a circle. The geometric shape 14 can also be an ellipse, oval, triangle, trapezoid or polygon, and the like.

FIG. 1C depicts a similar plan view as in FIG. 1A, except that the single-sided adhesive element 10 is pre-cut into a different irregular shape 16, namely a rectangle with rounded corners. Irregular shape 16 can be a shape more complicated than geometric shape 14. Irregular shape 16 can also be an irregular shape 18, depicted in FIG. 1D.

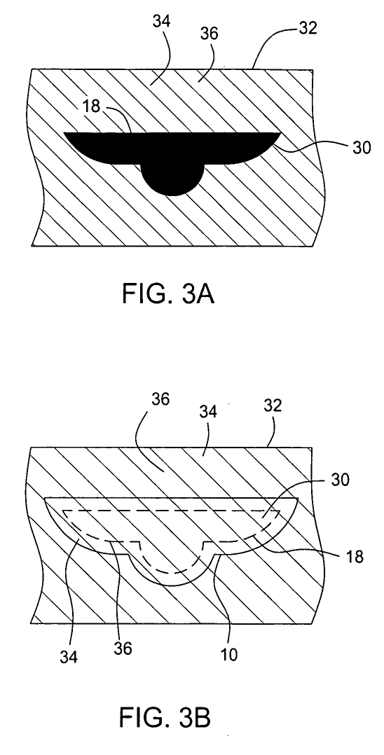

FIG. 2 depicts a sectional view of FIG. 1A cut along line a-a showing the adhesive side 20 and corresponding non-adhesive side 12. The non-adhesive side 12 of any one of the above shapes and sizes can be any backing used in the adhesive industry such as, but not limited to, bi-axially-oriented polypropylene backing (BOPP), cloth, crepe paper, fiber filled, fiberglass cloth, flatback paper, foil, foil/tri-directional/paper, or glass fiber—BOPP, and the like. The adhesive side 20 can be any adhesive used in the industry such as, but not limited to, acrylic, rubber, polyurethane, silicone or urethane, and the like. The rubber used for adhesive can be any rubber used in the adhesives industry such as, but not limited to, butyl rubber, flame retardant rubber, hot melt rubber, natural and synthetic rubber, natural rubber, synthetic rubber, or reclaim rubber, and the like.

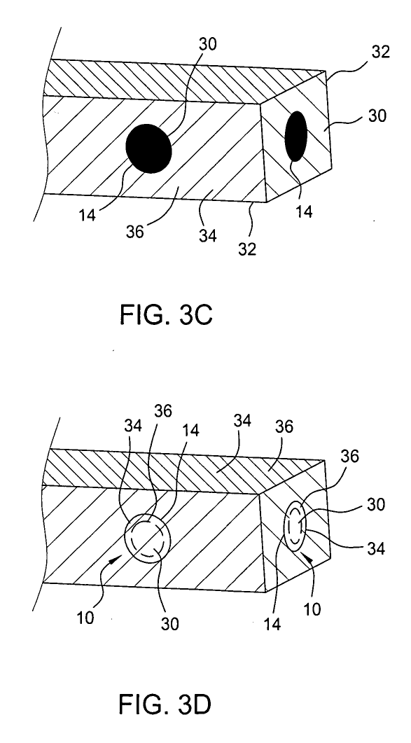

FIGS. 3A and 3B depict a plan view of an adhesive element receiving area 30 before and after a single-sided adhesive element 10 is applied. FIG. 3A illustrates an adhesive element receiving area 30 with an irregular shape 18. It should be noted that, although an irregular shape 18 is depicted, any of the other aforementioned shapes (i.e., geometric and irregular shapes) could be substituted interchangeably for this irregular shape 18. The adhesive element receiving area 30 is depicted here as a hole in material 32 having a texture 34 and color 36. However, it should be noted that the adhesive element receiving area 30 could be a gap or any other opening or area of repair.

FIG. 3B illustrates the adhesive element receiving area 30 after the single-sided adhesive element 10 is applied. The size and shape of the single-sided adhesive element 10 is chosen to substantially correspond to the size and shape of the adhesive element receiving area 30. In one embodiment, the single-sided adhesive element 10 is chosen to substantially correspond to the texture 34 and/or color 36 of the material 32. Based on the sizes and shapes of the adhesive element receiving area 30 or texture 34 and color 36 of the material 32, the single-sided adhesive element 10 can be manufactured in the corresponding sizes, shapes, textures and colors. As such, the single-sided adhesive element 10 is applied in a single application that corresponds substantially to the adhesive element receiving area 30.

FIGS. 3C and 3D depict perspective views of an adhesive element receiving area 30 of another embodiment before and after a single-sided adhesive element 10 is applied. Specifically, FIG. 3C illustrates an adhesive element receiving area 30 with a geometric shape 14 as found in an air duct system. The adhesive element receiving area 30 is depicted here as a round aperture in the material 32 having a texture 34 and color 36. The aperture may be made when the air ducts are being cleaned and the apertures are needed in the ducts to accommodate cleaning equipment such as vacuum hoses and cabling.

FIG. 3D illustrates the adhesive element receiving area 30 after the single-sided adhesive element 10 is applied. The size and shape of the single-sided adhesive element 10 is chosen to cover and substantially correspond to the size and shape of the adhesive element receiving area 30. Moreover, the single-sided adhesive element 10 can be chosen to substantially correspond to the texture 34 and color 36 of material 32. For example, the air duct could have a shiny metallic texture and a silver color. Alternative textures and colors are also contemplated and within the scope of the present invention. The adhesive element receiving area 30 may be a round area left after working on the air duct. Based on this, the single-sided adhesive element 10 is applied in a single application that covers and substantially corresponds to the adhesive element receiving area 30.

Applying the single-sided adhesive element 10 in a single application that corresponds substantially to the adhesive element receiving area 30 has many benefits. A single application will have less weight and bulk than applying multiple layers of narrow tape. Moreover, a single application is prone to leakage, collecting debris, or potential sites for tearing than multiple applications with narrow or ill-fitting tape. Also, a single application eliminates the need to manually alter the tape to substantially correspond with the adhesive element receiving area 30. This saves time and prevents waste of excess material, therefore, reducing costs.

In addition to the technical benefits realized by a single application of the single-sided adhesive element 10, there are also aesthetic benefits. Generally, a uniform, maintained appearance is preferred over a non-uniform, shoddy appearance. The single-sided adhesive element 10 can be manufactured in various textures and colors to match the texture 34 and color 36 of the material 32. FIG. 3B illustrates the single-sided adhesive element 10 having the same texture 34 and color 36 as the material 32. For example, as depicted in FIGS. 3C and 3D, one type of texture 34 could be a metallic, shiny appearance of air ducts and one type of color 36 could be silver. By having the same texture 34 and color 36 as the material 32, the single-sided adhesive element 10 is camouflaged.

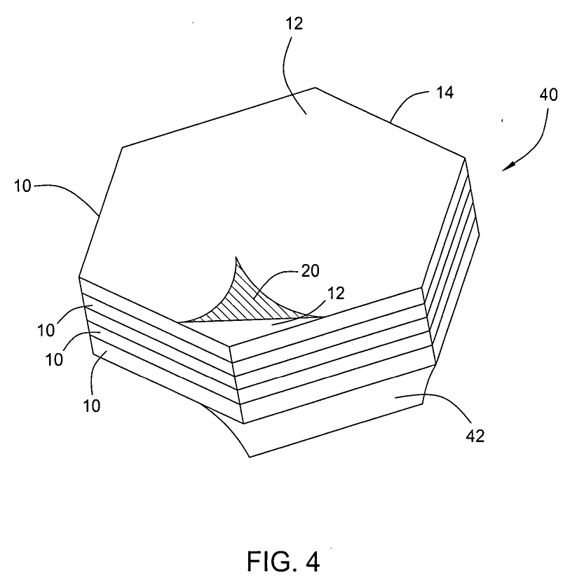

The single-sided adhesive element 10 can be commercialized to be dispensed in many ways, all of which are embodiments contemplated by, and within the scope of, the present invention. FIG. 4 depicts a perspective view of one embodiment of the present invention showing a plurality of single-sided adhesive elements 10 dispensable from a stack 40. The adhesive side 20 of one of the plurality of single-sided adhesive elements 10 removably contacts the non-adhesive side 12 of another one of the plurality of single-sided adhesive elements 10. The stack 40 is formed in this manner until the desired number of single-sided adhesive elements 10 is reached. The stack 40 is finished by removably contacting the adhesive side 20 of the bottom most single-sided adhesive element 10 with a non-adhesive backing 42.

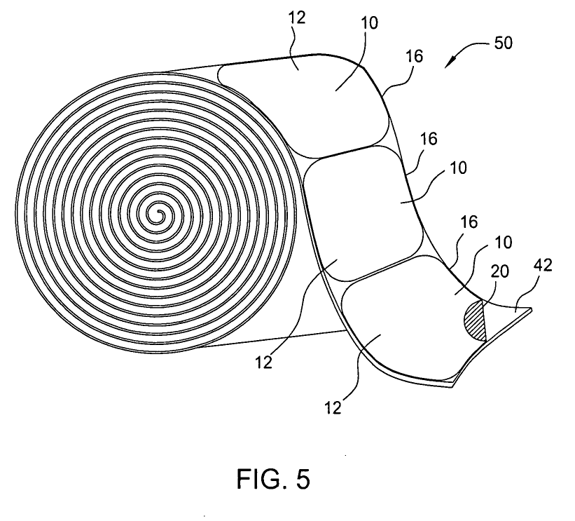

In another embodiment of the present invention, the single-sided adhesive element 10 can be dispensed in a roll 50 as depicted in FIG. 5. A plurality of single-sided adhesive elements 10 is dispensed. Roll 50 comprises a plurality of single-sided adhesive elements 10 placed adjacent each other on a non-adhesive backing 42. Although FIG. 5 illustrates an example of a roll 50 with the same irregular shape 16, roll 50 is not limited to a plurality of single-sided adhesive elements 10 with the same shape, but can also comprise a plurality of single-sided adhesive elements 10 with different shapes.

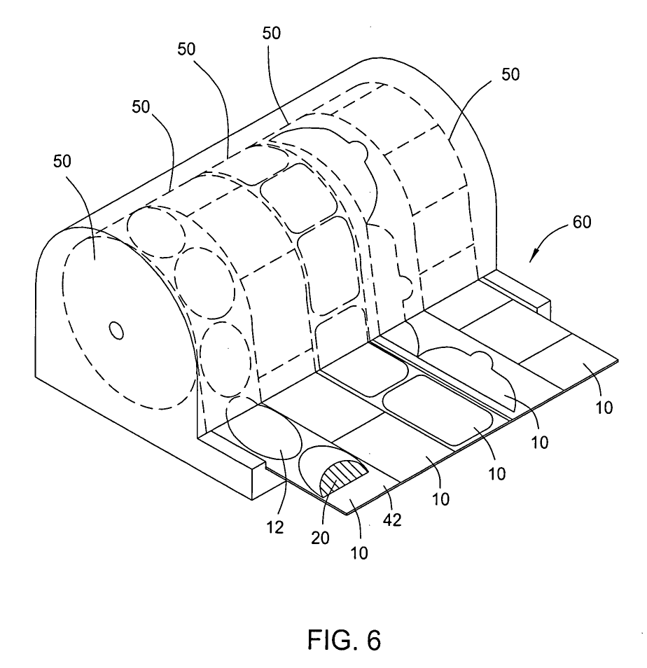

FIG. 6 depicts a perspective view of another embodiment of the present invention showing the single-sided adhesive element 10 dispensed in a plurality of rolls 50, which are contained in a single dispensing unit 60. The single dispensing unit 60 comprises a plurality of integrated rolls 50. Each roll 50 in single dispensing unit 60 is the same as roll 50 depicted in FIG. 5. Again, although FIG. 6 illustrates an example roll 50 with the same shapes, roll 50 is not limited to a plurality of single-sided adhesive elements 10 with the same shape, but can also comprise a plurality of single-sided adhesive elements 10 having different shapes.

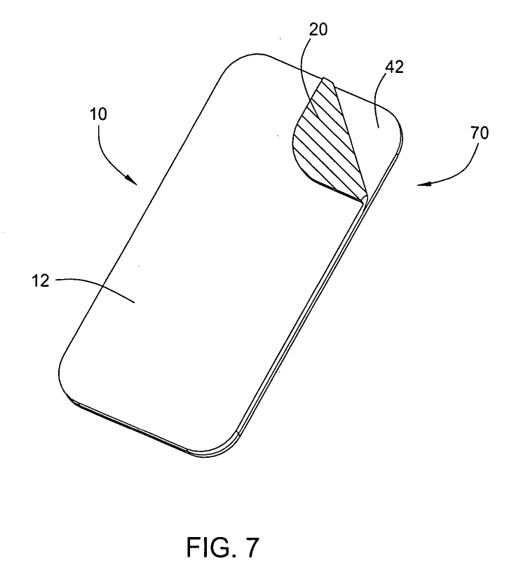

FIG. 7 depicts a perspective view of one embodiment of the present invention showing the single-sided adhesive element 10 dispensed as an individual unit 70. The adhesive side 20 is removably contacted with a non-adhesive backing 42. The single-sided adhesive element 10 can be packaged and sold as a plurality of individual units 70. The package of individual units 70 can all be the same shape or a mixture of different shapes.

In operation, a user may apply a single-sided adhesive element 10 to repair, seal, join, or fasten an adhesive element receiving area 30. Referring to FIG. 3A-3D, a user will determine the shape of the adhesive element receiving area 30, the texture 34 and color 36 of material 32. For example, a user may work on an air duct that has a shiny metallic texture and a silver color. While working, the user may need to create a large circular opening in the air duct. After the user finishes work on the air duct, the user will determine that he needs a circular-shaped single-sided adhesive element large enough to cover the opening. He may also determine that the adhesive element needs to have a shiny metallic texture and a silver color to match the receiving area.

Based on this information, the user removes the appropriate single-sided adhesive element 10 dispensed from a stack 40, roll 50, or a plurality of rolls 50 in a single dispensing unit 60. Then, the single-sided adhesive element 10 is applied. The single-sided adhesive element will substantially cover and conform to the shape of the corresponding adhesive element receiving area 30, the texture 34 and color 36 of material 32.

Finally, the single-sided adhesive element 10 can be included in a kit of components for repairing, sealing, joining or fastening for various applications. The kit of components comprises at least two single-sided adhesive elements 10. Referring to FIG. 3A-FIG. 3D, a user working on the adhesive element receiving area 30 on material 32 can utilize the kit of components to choose a single-sided adhesive element 10 that substantially corresponds to the shape and size of adhesive element receiving area 30 and the texture 34 and color 36 of material 32. The kit of components may comprise a plurality of single-sided adhesive elements 10 dispensed in a method or any combination of methods as described previously.

While the foregoing is directed to embodiments of the present invention, other and further embodiments of the invention may be devised without departing from the basic scope thereof, and the scope thereof is determined by the claims that follow.

1. A single-sided adhesive element, comprising:
an adhesive side; and
a corresponding non-adhesive side opposite the adhesive side,
wherein the single-sided adhesive element comprises a predetermined shape adapted to substantially cover and conform to the shape of a corresponding adhesive element receiving area.

2. The single-sided adhesive element of claim 1, wherein the adhesive side is selected from a group consisting of acrylic, rubber, polyurethane, silicone, and urethane.

3. The single-sided adhesive element of claim 2, wherein the rubber adhesive is selected from a group consisting of butyl rubber, flame retardant rubber, hot melt rubber, natural and synthetic rubber, natural rubber, synthetic rubber, and reclaim rubber.

4. The single-sided adhesive element of claim 1, wherein the corresponding non-adhesive side is selected from a group consisting of BOPP, cloth, crepe paper, fiber filled, fiberglass cloth, flatback paper, foil, foil/tri-directional/paper, and glass fiber-BOPP.

5. The single-sided adhesive element of claim 1, wherein the predetermined shape comprises a geometric shape.

6. The single-sided adhesive element of claim 5, wherein the geometric shape is a shape selected from a group consisting of a circle, ellipse, oval, triangle, parallelogram, trapezoid, and polygon.

7. The single-sided adhesive element of claim 1, wherein the predetermined shape comprises an irregular shape.

8. The single-sided adhesive element of claim 1, wherein the single-sided adhesive element further comprises a texture substantially corresponding to a texture of the corresponding adhesive element receiving area.

9. The single-sided adhesive element of claim 1, wherein the single-sided adhesive element further comprises a color substantially corresponding to a color of the corresponding adhesive element receiving area.

10. The single-sided adhesive element of claim 1, wherein the single-sided adhesive element is removably stackable.

11. A plurality of single-sided adhesive elements, each single-sided adhesive element comprising:
an adhesive side;
a corresponding non-adhesive side opposite the adhesive side,
wherein each single-sided adhesive element comprises a predetermined shape adapted to substantially cover a corresponding adhesive element receiving area.

12. The plurality of single-sided adhesive elements of claim 11, wherein the predetermined shapes consist of one or more of a geometric shape, and an irregular shape.

13. The plurality of single-sided adhesive elements of claim 12, wherein the geometric shape is selected from a group consisting of a circle, ellipse, oval, triangle, parallelogram, trapezoid, and polygon.

14. The plurality of single-sided adhesive elements of claim 11, wherein the plurality of single-sided adhesive elements are removably stacked such that the adhesive side of one of the plurality of single-sided adhesive elements removably contacts the non-adhesive side of another of the plurality of single-sided adhesive elements.

15. The plurality of single-sided adhesive elements of claim 11, wherein the plurality of single-sided adhesive elements are dispensable from a roll.

16. The plurality of single-sided adhesive elements of claim 15, wherein the adhesive side of each of the plurality of single-sided adhesive elements contacts a non-adhesive backing.

17. The plurality of single-sided adhesive elements of claim 15, wherein the plurality of single-sided adhesive elements comprise different predetermined shapes.

18. The plurality of single-sided adhesive elements of claim 11, wherein the plurality of single-sided adhesive elements are dispensable from a plurality of rolls.

19. The plurality of single-sided adhesive elements of claim 18, wherein at least one of the plurality of rolls comprises adhesive elements having different predetermined shapes.

20. A method of repairing, sealing, joining or fastening an adhesive element receiving area, comprising:
(a) providing at least one pre-shaped single-sided adhesive element adapted to substantially cover and conform to the shape of the corresponding adhesive element receiving area;
(b) applying the at least one pre-shaped single-sided adhesive element to the corresponding adhesive element receiving area.

21. A kit for repairing, sealing, joining or fastening industrial applications, the kit comprising at least two single-sided adhesive elements for use in an industrial application, where the at least two single-sided adhesive elements comprise an adhesive side and a corresponding non-adhesive side opposite the adhesive side, wherein the at least two single-sided adhesive elements further comprise a predetermined shape adapted to substantially cover and conform to the shape of a corresponding adhesive element receiving area.

22. The kit of claim 21, wherein at least one of the at least two single-sided adhesive elements has a different predetermined shape from the other of at least two single-sided adhesive elements.

23. The kit of claim 22, wherein the predetermined shape comprises one or more of a geometric shape, and an irregular shape.

24. The kit of claim 22, wherein the geometric shape is selected from a group consisting of a circle, ellipse, oval, triangle, parallelogram, trapezoid, and polygon.

25. The kit of claim 22, wherein the at least two single-sided adhesive elements are removably stackable.

26. The kit of claim 21, wherein the at least two single-sided adhesive elements are removably stacked such that the adhesive side of one of the at least two single-sided adhesive elements removably contacts the non-adhesive side of another of the at least two single-sided adhesive elements.
